(19) United States
(12) Patent Application Publication
(10) Pub. No.: US 2015/0008619 A1
(43) Pub. Date: Jan. 8, 2015

(54) METHOD AND DEVICE FOR PRODUCING A THREE-DIMENSIONAL PREFORM FROM A LAID SCRIM IN THE COURSE OF PRODUCTION OF FIBER REINFORCED MOLDED PARTS

(71) Applicant: Dieffenbacher GmbH Maschinen-und Anlagenbau, Eppingen (DE)

(72) Inventor: Steffen Maertiens, Bruchsal (DE)

(21) Appl. No.: 14/372,937

(22) PCT Filed: Jan. 18, 2013
(86) PCT No.: PCT/EP2013/050915

§ 371 Date: Jul. 17, 2014

(30) Foreign Application Priority Data
Jan. 18, 2012 (DE) 10 2012 200 701.6

(51) Int. Cl. B29B 11/00; B29C 70/48; B29B 13/02

(52) U.S. Cl. CPC B29B 11/00; B29B 13/022; B29C 70/48
USPC 264/319; 264/299; 425/356

(57) ABSTRACT

The invention relates to a method and a device for producing a three-dimensional preform (19) from a laid scrim (1) in the course of the production of fiber-reinforced molded parts, comprising a draping device (3) and a transport device (21) for the laid scrim (1), the draping device (3) comprising at least one draping mold (18) for a laid scrim (3) and means for shaping the laid scrim (3) in accordance with the contour of the draping mold (18), the means being movable relative to the draping mold (18). The aim of the invention is to ensure an expeditious and yet high-quality shaping, especially of large-surface-area and/or complex geometries of a preform. At least a first and a second tray (7) are used in the method as the transport device (21), the first tray (7) releasing the laid scrim (3) for fixation by means of a fixing ram (4) and/or a draping ram (5) and the second tray (7) then placing the laid scrim (1) in the draping mold (18) by way of a movement originating from the draping device.

The invention relates to a method for producing a three-dimensional preform from a laid scrim in the course of production of fibre-reinforced moulded parts according to the preamble of claim 1 and a device for producing a three-dimensional preform from a laid scrim as part of production of fibre-reinforced moulded parts according to the preamble of claim 9.

In the course of producing fibre-reinforced plastic components, which are also known as fibre composite parts, the RTM process (resin-transfer-moulding process) is used in practice, especially in the industry. The entire production process up to a useful plastic component consists of several, successively performed individual processes. Preforms/semi-finished fibre products which are close to the final shape are produced in a first method step. In this preform process, several layers of fabric or laid scrims (usually provided in two-dimensional form) are usually stacked and optionally joined (sewing, welding, gluing), so that the fibre fabric stack already substantially has the necessary outer contours and partly also comprises special layers or layer thicknesses. A binder is preferably introduced into the separating planes of the laid scrims, which upon reaching a formed three-dimensional shape and its activation and curing leads to a fixing of the layers with respect to each other and the draped 3D contour. For the preforming process, the fabric stacks are then transferred to a forming mould and transferred towards the contour of the future moulded part under pressure by closing the forming mould and cured by activation of the binder (heating and cooling), so that the semi-finished fibre product can be inserted close to its final contour into a mould of a press for performing the RTM process itself. The semi-finished fibre product will then be cut as required or punched out at predetermined positions in order to achieve an even more precise contour. After the insertion of the semi-finished fibre product into the mould, the mould halves are closed and the necessary resin is injected into the cavity of the mould, wherein the resin impregnates the fibre structure of the semi-finished fibre product, encloses the fibres and bonds them tightly into the resin matrix. The fibre-reinforced plastic component can then be removed from the mould after curing of the resin. In addition to the RTM process itself, the production of a semi-finished fibre product forms the foundation for the success in the production of a plastic component. It has been noticed that the state of the art describes a large number of possibilities for producing a preform, which are usually limited however to the manual or automated production of a fibre fabric stack which is as flat as possible and which is finally transferred from its 2D shape to a 3D shape in a press. This can be performed in a pre-fixed (e.g. sewed) state or still in a flexible state. The goal is to receive a preform after its shaping which has sufficient inherent rigidity in order to be inserted in a fully automated and operationally reliable manner into the mould of an RTM press, or which can be transported and removed from the stack for further use. There are various possibilities in the relevant state of the art for producing, shaping and fixing the preform.

In addition to the RTM process itself, the production of a semi-finished fibre product lays the foundation for the success in the production of a plastic component. The goal is to receive a preform from a non-rigid material after the shaping of the preform which is sufficiently rigid in order to be inserted in a fully automated and operationally reliable manner into the mould of an RTM press, or which can be transported and removed from the stack for further use. There are various possibilities in the relevant state of the art for producing, shaping and fixing the preform.

The following method steps are known for 3D forming of multilayer two-dimensional cutouts from fibre fabrics: fibre fabrics or laid scrims are wound off a roll and joined as required from several different fabrics or scrims, shapes and sizes into a fibre stack. It may be necessary to process or cut to size the outer and optionally the inner contour according to a cutting pattern of the preform or the plastic moulded part. The cutting pattern is produced from a development of the preform or the final component. The produced, substantially flat fibre stack is preferably draped by means of a draping device, or formed into a three-dimensional preform. In order to obtain a substantially rigid preform from a non-rigid fibre fabric it is mostly necessary that a binder is introduced between the individual layers and is subsequently cured.

It is state of the art that the fibre fabric or the fibre stack is heated by means of suitable heating apparatuses and is placed in a relatively cool or cold draping mould. The draping mould is then rapidly closed or draped accordingly in order to cure the binder. It has been noticed that preliminary solidification of the binder in the laid scrim may occur especially in the case of complex geometries or large-area laid scrims when it is partly provided with good heat transmission for cooling. A closure of the mould now causes problems in forming because stiff or cured regions act as brakes and produce undesirable stress on the individual layers of the laid scrim. Shifting, vertical creases or similar problems occur in the careful configuration of the laid scrim, which endangers the consistency and quality of the future component. In order to avoid this, heating is usually performed clearly above the melting or activation temperature of the binder, which may lead to undesirable distortions in the laid scrim and also entails unnecessarily high energy consumption. Furthermore, a strongly heated laid scrim cannot be manipulated as well anymore.

It is the object of the invention to provide a method and a device in which despite rapid forming, especially of large-area and/or complex geometries, high-quality forming of the preform can be ensured.

This object of the method is achieved in such a way that at least one first and one second tray is used as a transport apparatus, wherein the first tray releases the laid scrim for fixing by means of a fixing stamp and/or a draping stamp and subsequently the second tray successively places the laid scrim in the draping mould by a movement originating from the draping device.

Means (e.g. actuating apparatuses, drives or the like) must be arranged for this purpose, which allow moving the first tray independently in relation to the second tray, although both trays jointly form the transport apparatus for the laid scrim in the draping device. For example, the first tray can be hinged on the second tray or be displaced in and/or beneath the first tray. It is especially provided that in the case of a highly complex geometry the transport apparatus consists of a plurality of trays for optimal draping in the draping mould, which trays can be moved independently from each other out of the draping mould. If this is insufficient for draping, the released areas of the laid scrim which are no longer supported are draped successively by the draping stamps.

The laid scrim can preferably be heated on at least one tray. For this purpose, a tempering apparatus is preferably arranged on the tray or is operatively connected thereto. Preferably, the temperature of an already tempered laid scrim on the transport apparatus or the tray is set to and/or held at a predetermined minimum temperature. The minimum temperature should preferably substantially correspond to the melting point of the binder within the laid scrim.

It may be useful to maintain tension in the laid scrim by the draping stamps or the fixing stamps and the tray which still carries the laid scrim. A retaining apparatus which is provided on the tray operatively connected thereto can be used in particular for establishing the tension. A combination of one or several belt trays and one or several trays can also be considered as a transport apparatus in the case of complex geometries of the preform or the draping mould.

The object for an apparatus is achieved in such a way that at least one first and one second tray is arranged as a transport apparatus, wherein means for the independent movement of the first tray in relation to the second tray are arranged on the first tray for releasing the laid scrim for fixing by means of a fixing stamp and/or a draping stamp.

The device is especially suitable for performing the method, but can also be operated independently. It is advantageously now possible.

Further advantageous measures and embodiments of the subject matter of the invention are provided in the sub-claims and the following description with the drawings.

The possibilities for combination as represented in the description of the drawings can be utilised either independently and separately and in any combination. In particular, individual sentences shall also be construed as independent features.

The drawings show as follows:

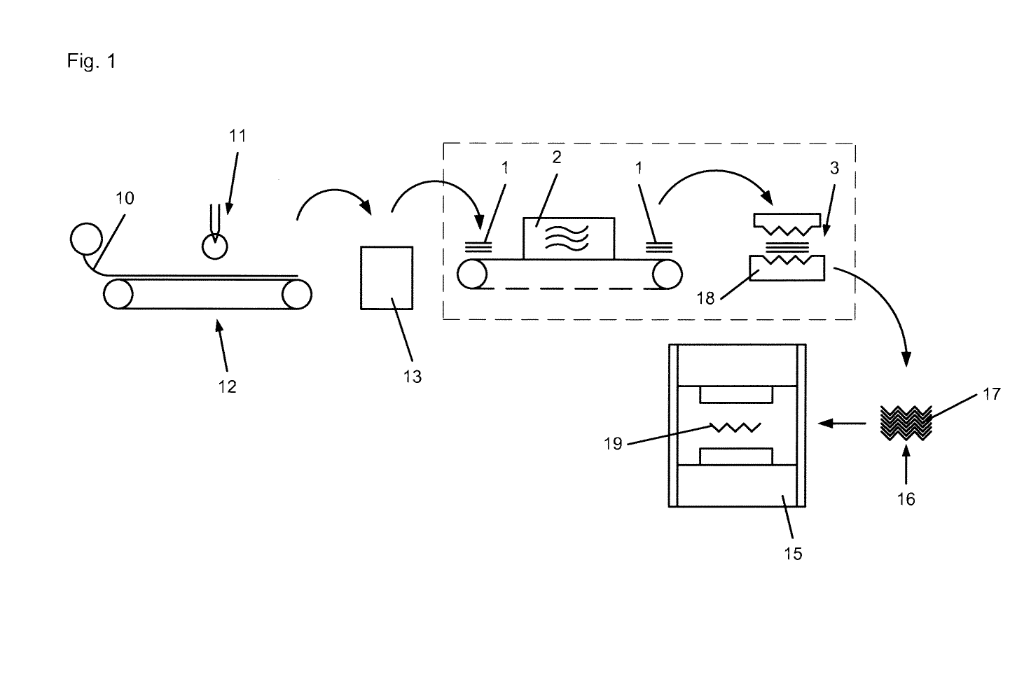

FIG. 1 shows an installation for producing fibre-reinforced moulded parts in a press by using preformed preforms as major industrial application in a schematic side view;

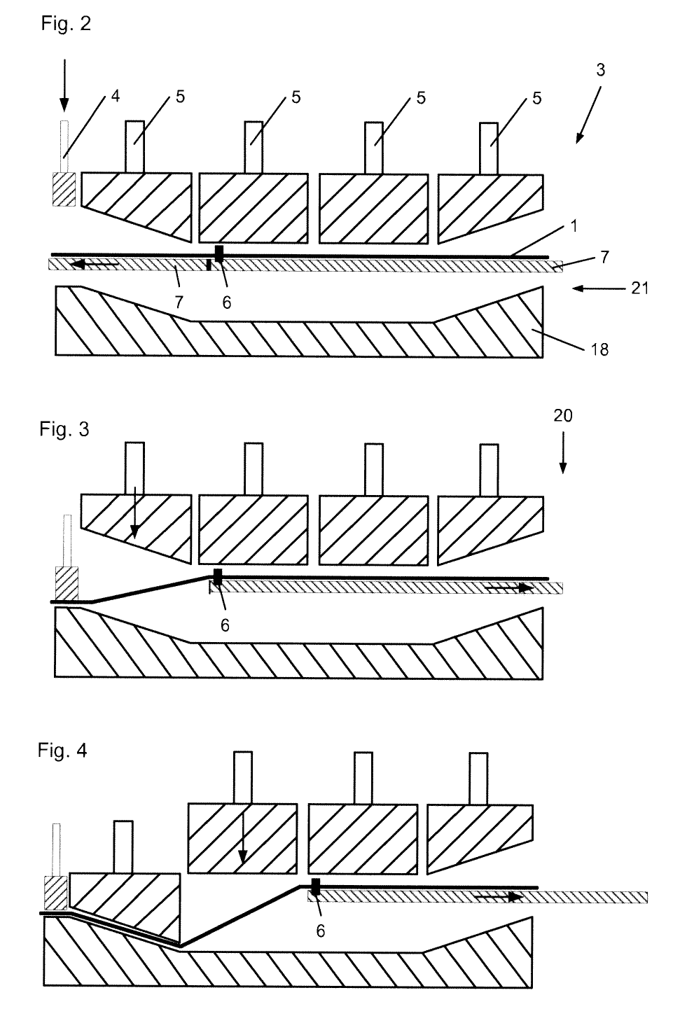

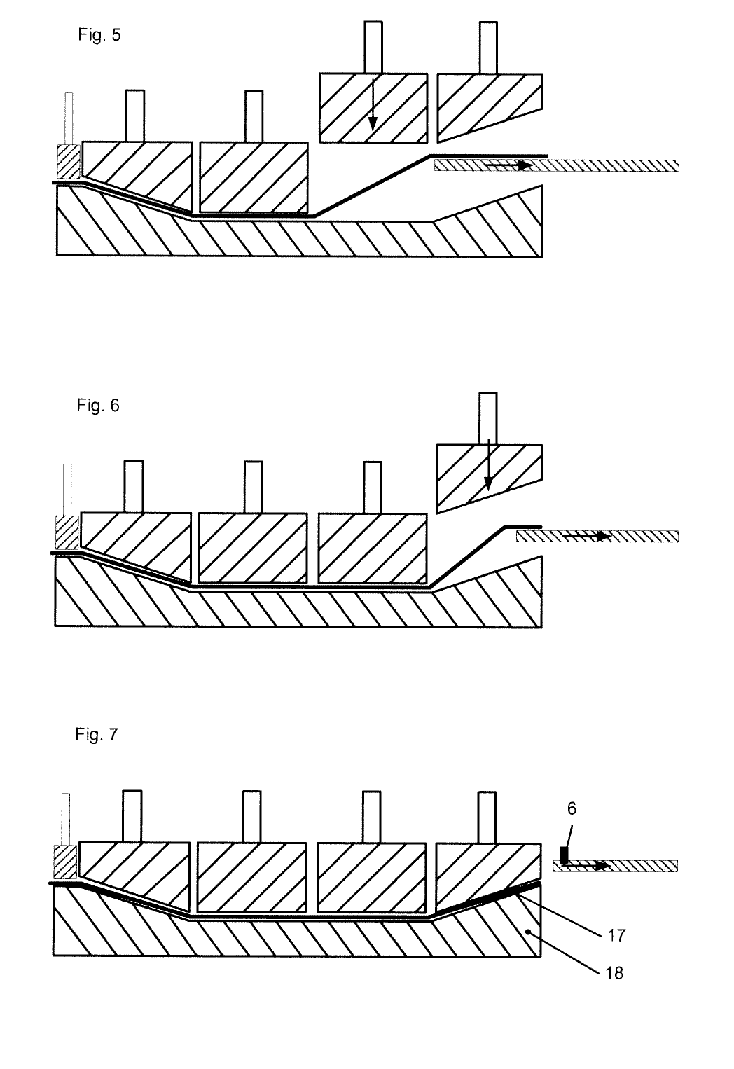

FIGS. 2 to 7 show a divided tray as a transport apparatus for the laid scrim in a draping device with an illustration of a possible step-by-step or continuous depositing of the laid scrim in the draping mould, and

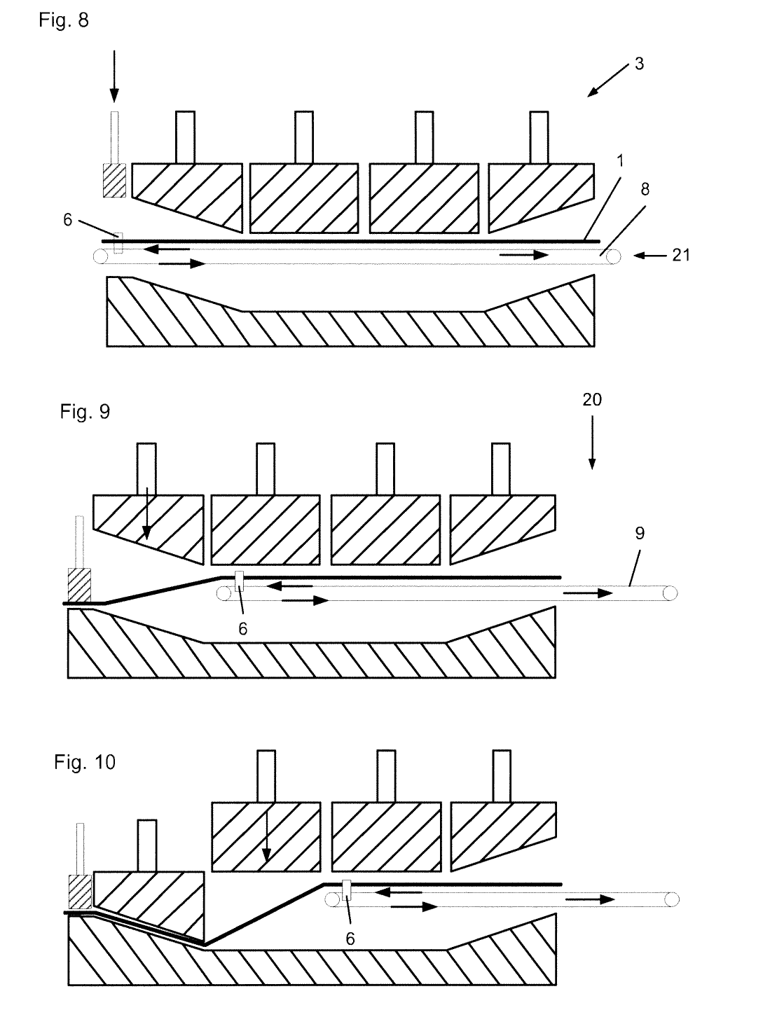

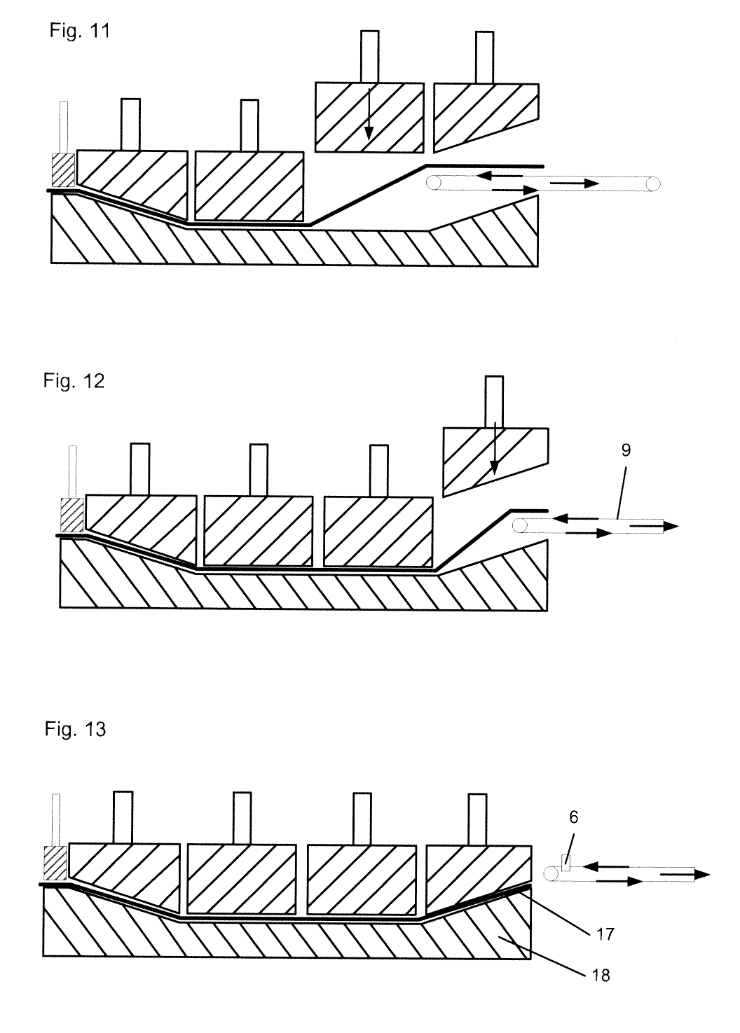

FIGS. 8 to 13 show the use of a belt tray as a transport apparatus according to the example of FIGS. 2 to 7.

FIG. 1 shows an installation for producing fibre-reinforced moulded parts 19 in an RTM press 15 by using preformed preforms 17 in large-scale industrial production in a schematic side view. For the purpose of producing preforms 17, one or several different fibre mats 10 are provided, preferably as roll merchandise, and cut on a cutting apparatus 12 with a cutting apparatus 11 into individual fibre mat cutouts (not shown). The contour of the fibre mat cutouts can substantially coincide with the contour of the preform 17 or the moulded part 19. It is also possible to produce predetermined partial geometries thereof. The fibre mat cutouts are then moved by means of a suitable transport apparatus (which is represented in FIG. 1 by the bent directional arrows) through a glue application apparatus 13 and are provided there with binder before they are joined into a laid scrim 1. Depending on the installation, the completed laid scrim 1 is subsequently tempered by a heating apparatus 2 and preferably increased to a temperature which corresponds at least to the melting temperature of binder. The laid scrim 1 is then moved to a draping device 3 and formed there by suitable means along the contour of the draping mould 18. The laid scrim 1 is subjected to cooling by the draping mould 18 of the draping device 3 and solidifies into a preform 16 which can usually be intermediately stacked without any problems on a stack 17 before it is pressed in an RTM press 15 into a reinforced moulded part 19.

A possible transport apparatus 21 is described in FIGS. 2 to 7, which is arranged in this case as a divided tray 7. A separate illustration of the optional tempering apparatus was omitted for reasons of clarity of the illustration. If a laid scrim 1 is preheated or is placed in a cold state on the transport apparatus 21 the transport apparatus can heat up the laid scrim 1 by means of the tempering apparatus, which is arranged in the tray 7 or also in an entrained fashion above the tray 7, or it will keep its existing temperature at least above the melting point of the binder.

If the transport apparatus 21 has moved into the draping device 3, the first part of the tray can be moved out of engagement with a part of the laid scrim 1 in the case of a divided tray 7. Different possibilities can be considered such as folding in, retracting or the like in the second part of the tray 7 itself or even purposeful extension of the first part of the tray 7 from the draping device 3. It is possible that the necessary number of the parts of the tray 7 is a multiple and that at least one of these parts, and preferably all of them, are provided with the possibility for tempering or contain a tempering apparatus. Preferably, but not necessarily, a first fixing stamp 4 or a draping stamp 5 can respectively fix the released region of the laid scrim 1 on the draping mould 18 and also optionally form said scrim. Depending on the frictional resistance of the individual machine elements, the second part of the tray 7 can start to move out of the draping device 3, which occurs step-by-step or continuously as required. As is shown in FIGS. 3 to 7, the draping stamps 5 which are now retracted in the draping direction 20 will form the laid scrim according to the contour of the draping mould 18 according to the “released” regions of the laid scrim 1 (which no longer lie on the transport apparatus). This occurs in the present example by the successive displacement of four draping stamps 5 in the draping direction 20. As a result, it is now possible to form an evenly preheated or tempered laid scrim 1 into a preform 17 in all regions of the draping mould 18.

In FIGS. 8 to 13, a belt tray 8 is arranged instead of a tray 7 as a transport apparatus 21. The belt tray should be divided in accordance with the invention. It can also be associated with an element supporting the laid scrim 1 or a tray 7, which realizes the teachings of the invention. A tempering apparatus is also not shown in this case, but it can be effectively provided in order to set or hold the laid scrim 1 resting on the belt tray 8 according to its temperature. The laid scrim 1 can be placed carefully in the draping mould 18 by the rolling belt 9 of the belt tray 8 and a simultaneous relative movement of the belt tray 8. The fixing of the first part of the laid scrim by means of a fixing stamp 4 can be provided as a precaution, especially in the case of complex geometries, but this is not necessary in the case of simple geometries of the draping mould 18.

It is also possible to provide other suitable means for draping instead of the draping stamp 5.

The tempering apparatus can be arranged as a convection radiator or also as a (resistance) heating apparatus for the transport apparatus 21. The described tray 7 is preferably heated to a respective temperature which is sufficient to respectively heat the laid scrim by means of the radiation heat emitted by the tray 7, or its potentially sufficient temperature is held above the melting point of the binder.

Depending on the application, the transport apparatus 21 can be subdivided several times by individual extension or place the laid scrim according to requirements by a combination of the described possibilities. It can be considered in particular that the depositing of the laid scrim 1 needs to commence in the middle or in a boundary region or at two or more points simultaneously. It still remains a fact in a long-term draping process for example that laid scrims that have not yet been draped and placed on the draping mould 18 are heated to a sufficient temperature.

### LIST OF REFERENCE NUMERALS: DP 1432

1. Laid scrim

2. Heating apparatus

3. Draping device

4. Fixing stamp

5. Draping stamp

6. Retaining apparatus

7. Tray

8. Belt tray

9. Belt

10. Fibre mat

11. Cutting apparatus

12. Cutting table

13. Glue application apparatus

14. Preform

15. RTM press

16. Stack

17. Preform

18. Draping mould

19. Moulded parts

20. Draping direction

21. Transport apparatus

1. A method for producing a three-dimensional preform from a laid scrim in the course of production of fibre-reinforced moulded parts, comprising a draping device and a transport apparatus for the laid scrim, wherein the draping device comprises at least one draping mould for a laid scrim, and means displaceable to the draping mould for forming the laid scrim according to the contour of the draping mould, characterized in that at least one first and one second tray is used as a transport apparatus, wherein the first tray releases the laid scrim for fixing by a fixing stamp and/or a draping stamp, and subsequently the second tray successively places the laid scrim in the draping mould by a movement originating from the draping device.

2. A method according to claim 1, characterized in that the laid scrim is heated on the tray.

3. A method according to claim 1, characterized in that the temperature of an already tempered laid scrim is set to and/or held at a predetermined minimum temperature on a belt tray.

4. A method according to claim 2, characterized in that the minimum temperature substantially corresponds to the melting point of a binder within the laid scrim.

5. A method according to claim 1, characterized in that the draping stamps successively drape the regions of the laid scrim which are released by the second tray into the draping mould.

6. A method according to claim 1, characterized in that the laid scrim is held under tension by the draping stamp or the fixing stamp and the tray.

7. A method according to claim 6, characterized in that a retaining apparatus is used for establishing the tension.

8. A method according to claim 1, characterized in that a combination of one or several belt trays and one or more first and second trays is used as a transport apparatus.

9. A device for producing a three-dimensional preform from a laid scrim in the course of production of fibre-reinforced moulded parts, comprising a draping device and a transport apparatus for the laid scrim, wherein the draping device at least comprises one draping mould for a laid scrim, and means displaceable to the draping mould for forming the laid scrim according to the contour of the draping mould, characterized in that at least one first and one second tray is arranged, wherein means for the independent movement of the first tray in relation to the second tray are arranged on the first tray for releasing the laid scrim for fixing by a fixing stamp and/or a draping stamp.

10. A device according to claim 9, characterized in that a tempering apparatus is arranged on at least one tray at least for maintaining the temperature of a preheated laid scrim and/or for heating the laid scrim over the melting point of the binder within the laid scrim.

11. A device according to claim 9, characterized in that at least a divided tray and a belt tray are arranged as a transport apparatus.

12. A device according to claim 9, characterized in that for introducing a tension into the laid scrim a retaining apparatus for the laid scrim is associated with or arranged on the second tray.
